(19) United States
(12) Patent Application Publication
(10) Pub. No.: US 2019/0129151 A1
(43) Pub. Date: May 2, 2019

(54) IMAGING OPTICAL SYSTEM, IMAGE PROJECTION APPARATUS, AND IMAGING APPARATUS

(71) Applicant: CANON KABUSHIKI KAISHA, Tokyo (JP)

(72) Inventor: Makoto Takahashi, Utsunomiya-shi (JP)

(21) Appl. No.: 16/165,020

(22) Filed: Oct. 19, 2018

(30) Foreign Application Priority Data
Oct. 30, 2017 (JP) 2017-209690

(51) Int. Cl. G02B 13/04; G02B 13/18; G02B 15/16

(52) U.S. Cl. CPC G02B 13/04; G02B 15/161; G02B 13/18

(57) ABSTRACT

An imaging optical system includes, in order from an enlargement conjugate side, a front unit, a diaphragm, and a rear unit. The front unit includes, in order from the enlargement conjugate side, a first lens having a negative refracting power, a second lens having at least one aspherical surface and a meniscus shape with a negative refracting power, and a third lens having an aspherical surface on the enlargement conjugate side and a negative refractive power. The second lens has a positive refractive power at a periphery, and a surface in which the periphery and a center have curvatures with different signs. The third lens has a concave surface on the enlargement conjugate side. A predetermined condition is satisfied.

### BACKGROUND OF THE INVENTION

### Field of the Invention

The present invention relates to an imaging optical system, an image projection apparatus, and an imaging apparatus.

### Description of the Related Art

Recent projectors have been strongly required for a wide angle for a short distance projection, as well as a miniaturization and a high definition. In addition, since a space for arranging elements, such as a prism, used for a color combination is required between an image display element and a projection lens, it is necessary to secure a predetermined back focus. As an optical system satisfying the condition of a wide angle and a long back focal length, a retrofocus type imaging optical system is proposed (see Japanese Patent Laid-Open Nos. (“JPs”) 2006-113446 and 2013-195747) which includes a negative lens on a screen side (enlargement conjugate side) and a lens unit having a positive refractive power on an image display element side (reduction conjugate side).

Since the retrofocus type imaging optical system has an asymmetric structure between a front unit on the enlargement conjugate side and a rear unit on the reduction conjugate side, an off-axis aberration such as a field curvature and a distortion occur and the optical performance lowers. JP 2006-113446 uses an aspherical lens for a second lens from the enlargement conjugate side in order to reduce the off-axis aberration, but the off-axis aberration correction is insufficient and the optical performance becomes insufficient. JP 2013-195747 uses an aspherical lens for a third lens from the enlargement conjugate side, in addition to the second lens from the enlargement conjugate side so as to improve the off-axis aberration correction effect, but the lens that does not have an optimal shape complicates the lens configuration.

### SUMMARY OF THE INVENTION

The present invention provides an imaging optical system, an image projection apparatus, and an imaging apparatus having a wide angle, a simplified configuration, and an excellent optical performance

An imaging optical system according to one aspect of the present invention includes, in order from an enlargement conjugate side, a front unit, a diaphragm, and a rear unit. The front unit includes, in order from the enlargement conjugate side, a first lens having a negative refracting power, a second lens having at least one aspherical surface and a meniscus shape with a negative refracting power, and a third lens having an aspherical concave surface on the enlargement conjugate side and a negative refractive power. The second lens has a positive refractive power at a periphery, and a surface in which the periphery and a center have curvatures with different signs each other. The following conditional expression is satisfied:

0.5r≤rk≤0.75r

where rk is a distance from an optical axis to a position corresponding to an arbitrary extreme value on the surface of the second lens in which the periphery and a center have curvatures with different signs each other, in a direction orthogonal to the optical axis, and r is a lens radius.

Further features of the present invention will become apparent from the following description of exemplary embodiments with reference to the attached drawings.

### BRIEF DESCRIPTION OF THE DRAWINGS

FIG. 1 is a simplified block diagram of an image projection apparatus including an imaging optical system according to a first embodiment.

FIG. 2 is a longitudinal aberration diagram at a wide-angle end of the imaging optical system according to the first embodiment.

FIG. 3 is a longitudinal aberration diagram at a telephoto end of the imaging optical system according to the first embodiment.

FIG. 4 is a sectional view of a surface shape on a reduction side of a second lens according to the first embodiment.

FIG. 5 illustrates a change amount in the surface inclination on the reduction side of the second lens according to the first embodiment.

FIG. 6 schematically illustrates an image projection apparatus including an imaging optical system according to the first embodiment.

FIG. 7 schematically illustrates an image pickup apparatus including an imaging optical system according to the first embodiment.

FIG. 8 is a simplified configuration diagram of an image projection apparatus including an imaging optical system according to a second embodiment.

FIG. 9 is a longitudinal aberration diagram at a wide-angle end of the imaging optical system according to the second embodiment.

FIG. 10 is a longitudinal aberration diagram at a telephoto end of the imaging optical system according to the second embodiment.

FIG. 11 is a simplified block diagram of an image projection apparatus including an imaging optical system according to a third embodiment.

FIG. 12 is a longitudinal aberration diagram at a wide-angle end of the imaging optical system according to the third embodiment.

FIG. 13 is a longitudinal aberration diagram at a telephoto end of the imaging optical system according to the third embodiment.

FIG. 14 is a simplified configuration diagram of an image projection apparatus including an imaging optical system according to a fourth embodiment.

FIG. 15 is a longitudinal aberration diagram of an imaging optical system according to the fourth embodiment.

### DESCRIPTION OF THE EMBODIMENTS

Referring now to the accompanying drawings, a detailed description will be given of embodiments according to the present invention. In each figure, the same reference numerals are given to the same elements, and a duplicate description thereof will be omitted.

### First Embodiment

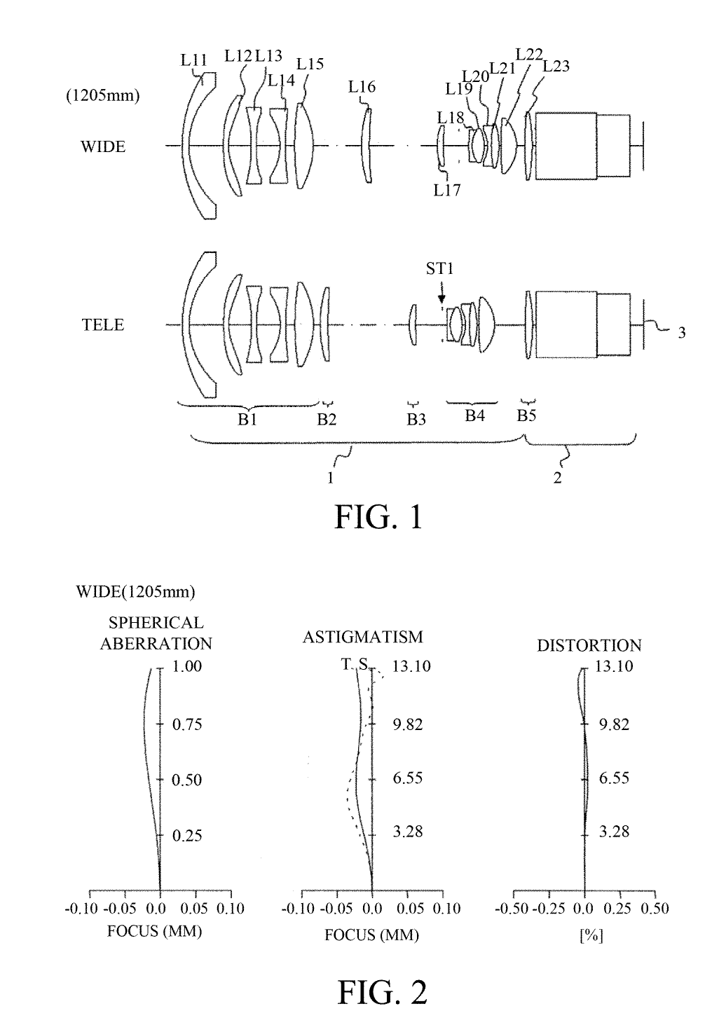

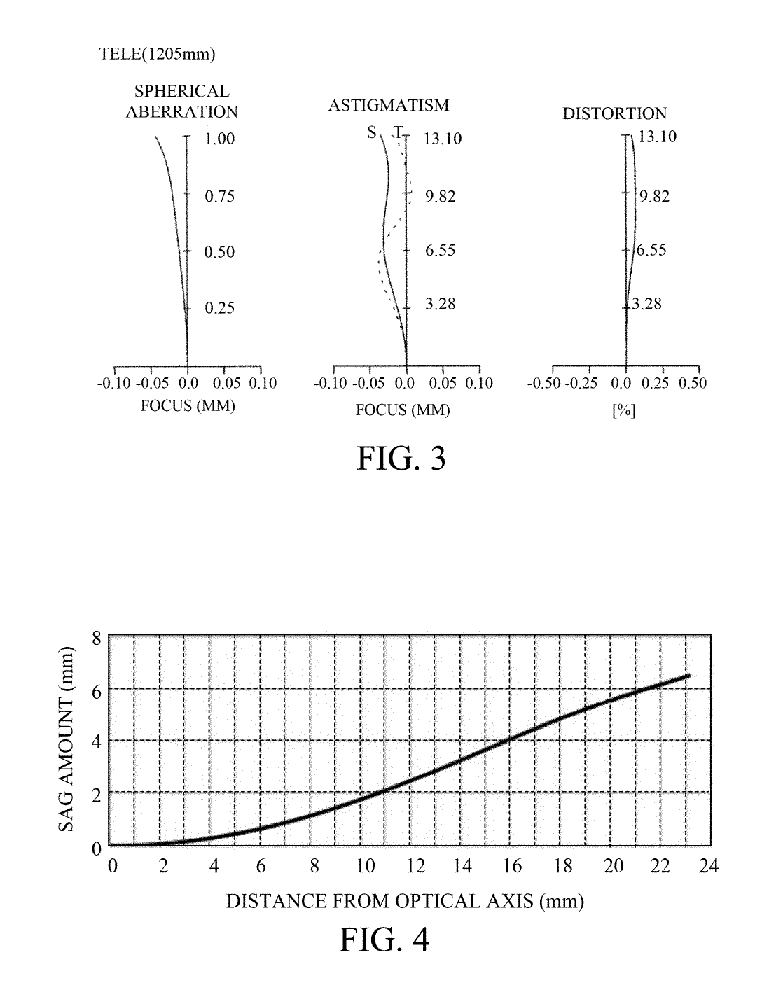

Referring now to FIG. 1, a description will be given of a principle and effects of the present invention. FIG. 1 illustrates a simplified configuration of an image projection apparatus using the imaging optical system (with a projection distance of 1205 mm) according to this embodiment as a projection lens. The image projection apparatus includes, in order from an enlargement conjugate side, an imaging optical system 1, a prism unit 2, and an image display element 3. FIG. 2 is a longitudinal aberration diagram of the imaging optical system 1 at a wide-angle end. FIG. 3 is a longitudinal aberration diagram at a telephoto end of the imaging optical system 1.

The imaging optical system 1 includes, in order from the enlargement conjugate side, a front unit, a diaphragm ST1, and a rear unit. The front unit includes, in order from the enlargement conjugate side, a first lens unit B1 that is fixed in a magnification variation and has a negative refractive power, a second lens unit B2 that is movable in the magnification variation and has a positive refractive power, and a third lens unit B3 that is movable in the magnification variation and has a positive refractive power. The rear unit includes, in order from the enlargement conjugate side, a fourth lens unit B4 that is movable in the magnification variation and has a negative refractive power, and a fifth lens unit B5 that is fixed in the magnification variation and has a positive refractive power.

The first lens unit B1 includes, in order from the enlargement conjugate side, a lens L11 having a negative refractive power, a lens L12 having a negative refractive power and a meniscus lens with a negative refractive power, a lens L13 having a negative refractive power and an aspherical surface on the enlargement conjugate side, a lens L14 having a negative refractive power, and a lens L15 having a positive refractive power. The second lens unit B2 includes a lens L16 having a positive refractive power. The third lens unit B3 includes a lens L17 having a positive refractive power. The fourth lens unit B4 includes, in order from the enlargement conjugate side, a lens L18 having a negative refractive power, a lens L19 having a positive refractive power, a lens L20 having a negative refractive power, a lens L21 having a positive refractive power, and a lens L22 having a positive refractive power. The fifth lens unit B5 includes a lens L23 having a positive refractive power.

The lens (first lens) L11, the lens (second lens) L12, and the lens (third lens) L13 can stepwise bend a light ray with a large off-axis angle of view and suppress the off-axis aberration. Since the lens L11 is disposed closest to the enlargement conjugate side, it is necessary to enhance the weather resistance and impact resistance. A plastic molded lens is not suitable because of the characteristic difficulties. A glass molded lens has a large lens diameter and causes a cost increase.

This embodiment enhances the weather resistance and impact resistance by using a glass spherical lens as the lens L11, and the lens L12 and the lens L13 disposed at positions where the ray height of the off-axis light is high are aspherical, and thereby efficiently corrects the field curvature and distortion.

In general, the retrofocus type lens suppresses the spherical aberration and coma aberration by reducing the refractive power of the meniscus lens on the enlargement conjugate side and gently bending the light. However, the reduced refractive power lowers the correcting effect of the off-axis aberration. A plastic molded lens having a large refractive power used for the meniscus lens causes a large focus movement amount in the thermal change, and it is difficult to increase the refractive power of the lens.

This embodiment does not make large the refractive power of the lens L12 near the optical axis so much, and corrects the off-axis aberration. More specifically, the lens L12 has a positive refractive power only at the periphery, and largely bends the light flux at the periphery in the optical axis direction. This configuration can cause the image display element 3 to generate a positive distortion, and reduce the distortion of the entire lens system. Herein, the periphery is an area where the outermost light flux on the lens surface enters.

In this embodiment, the lens L13 on the enlargement conjugate side has a concave surface. Thereby, an incident angle on the lens L13 increases, and the negative distortion correction effect and the positive field curvature correction effect at the periphery become larger.

The above configuration enables the imaging optical system 1 according to this embodiment to correct the distortion and the field curvature of the entire lens system.

FIG. 4 is a sectional view of the surface shape of the lens L12 on the reduction conjugate side, and illustrates the lens surface shape changing from the optical axis to the periphery of the lens. The abscissa axis represents a distance from the optical axis in the direction orthogonal to the optical axis, and the ordinate axis represents a sag amount along the optical axis. This embodiment sets the direction orthogonal to the optical axis to the y direction and the optical axis direction to the z direction.

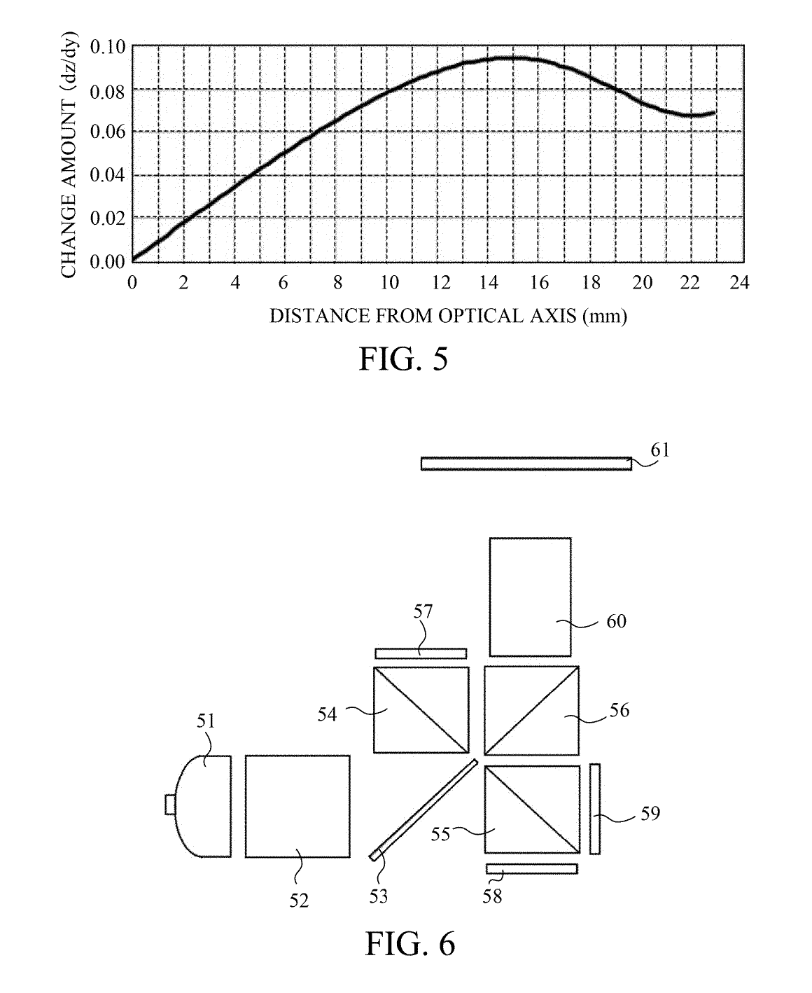

FIG. 5 illustrates a slope changing amount (differential curve dz/dy in FIG. 4) of a surface of the lens L12 on the reduction conjugate side. As illustrated in FIG. 5, a differential value increases from the optical axis to the periphery of the lens, and decreases after it reaches the maximum value. Therefore, in this embodiment, the sign of the curvature of the periphery is different from that of the curvature of the center part on the reduction conjugate side of the lens L12. This embodiment defines as an extreme value a value with a differential value that changes from an increase to a decrease or a value with a differential value that changes from a decrease to an increase.

The surface shape of the lens L12 on the reduction conjugate side satisfies the following conditional expression (1) where rk is a distance from the optical axis to a position corresponding to an arbitrary extreme value in the y direction and r is a lens radius. The lens radius may be an effective radius as a distance from the optical axis to the outermost light ray passing through the lens surface or may be a physical radius of the lens.

0.5r≤rk<1.0r (1)

Satisfying the conditional expression (1) can realize an imaging optical system having a good optical performance When the conditional value exceeds the lower limit in the conditional expression (1), the refractive power at the center part of the lens L12 becomes excessively strong, a positive distortion becomes large, and the optical performance deteriorates. When the conditional value exceeds the upper limit in the conditional expression (1), the refractive power at the periphery of the lens L12 becomes excessively small, the positive distortion is insufficiently corrected, and the optical performance deteriorates.

Setting the numerical range of the conditional expression (1) as follows can realize an imaging optical system having a good optical performance.

0.5r≤rk≤0.75r (1)′

In this embodiment, the sign of the curvature of the periphery is different from that of the curvature of the center part on the surface on the reduction conjugate side of the lens L12, but on the surface on the enlargement conjugate side of the lens L12, the sign of the curvature of the periphery may be different from that of the curvature of the center part.

The imaging optical system 1 satisfies the following conditional expression (2) where φ2 is a refractive power of the lens L12 is and φ3 is a refractive power of the lens L13.

0.6≤φ2/φ3≤4.0 (2)

Satisfying the conditional expression (2) can realize an imaging optical system having a good optical performance If the conditional value exceeds the lower limit in the conditional expression (2), the refractive power of the lens L13 becomes excessively large, the positive field curvature becomes excessive, and the image surface performance of the lens deteriorates. If the conditional value exceeds the upper limit in the conditional expression (2), the refractive power of the lens L13 becomes excessively small, the positive field curvature becomes insufficiently corrected, and the image plane performance of the lens deteriorates.

The conditional expression (2) may be replaced as follows for an imaging optical system having a good optical performance.

0.8≤φ2/φ3≤2.50 (2)′

The imaging optical system 1 according to this embodiment satisfies each conditional expression as shown in “(C) value of conditional expression” in Numerical Example 1.

The above configuration can realize a retrofocus type imaging optical system having a simple configuration and a good optical performance because the off-axis aberration is corrected. This embodiment uses the imaging optical system 1 as a projection lens, but the present invention is not limited. The imaging optical system 1 may be used, for example, as an imaging lens for an imaging apparatus. In this embodiment, the imaging optical system 1 is a zoom lens, but the present invention is not limited.

FIG. 6 schematically illustrates an image projection apparatus having the imaging optical system 1 according to this embodiment as a projection optical system. An illumination optical system 52 serves to align the polarization direction of the light emitted from a light source 51 with an arbitrary direction of the P or S direction in order to evenly illuminate the image display element. A color separation optical system 53 separates the light from the illumination optical system 52 into arbitrary colors corresponding to the image display elements. Polarization beam splitters 54 and 55 transmit or reflect the incident light. Reflection type image display elements 57, 58, and 59 modulate incident light in accordance with an electric signal. The color combination optical system 56 combines the light fluxes from respective image display elements into one. A projection optical system 60 includes the imaging optical system 1 according to this embodiment and projects the light combined by the color combination optical system 56 onto a projection surface, such as a screen 61. The illumination optical system 52, the color separation optical system 53, the polarization beam splitters 54 and 55, and the color combination optical system 56 constitute a light guiding optical system for guiding light from the light source 51 to the image display elements.

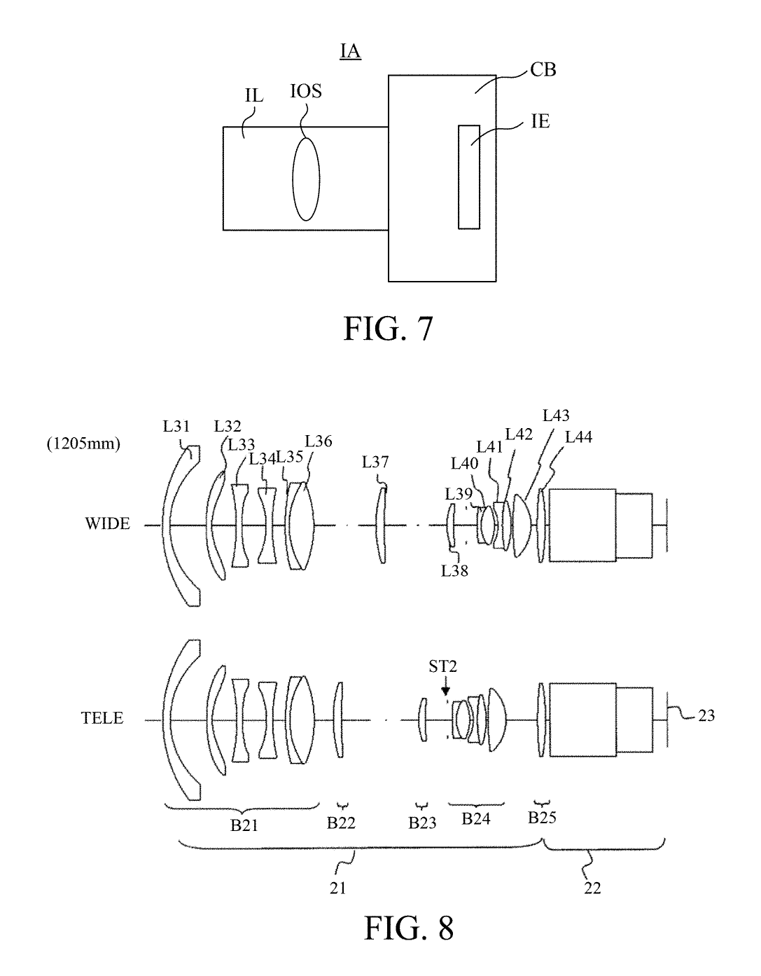

FIG. 7 schematically illustrates an imaging apparatus IA having the imaging optical system 1 according to this embodiment as an imaging optical system IOS. The imaging optical system IOS is held by an imaging lens IL. A camera body CB holds an image sensor IE that receives an image formed by the imaging optical system IOS. The imaging lens IL may be integrated with the camera main body CB or may be detachably attached to the camera main body CB. The imaging lens IL may hold the imaging element IE.

### Second Embodiment

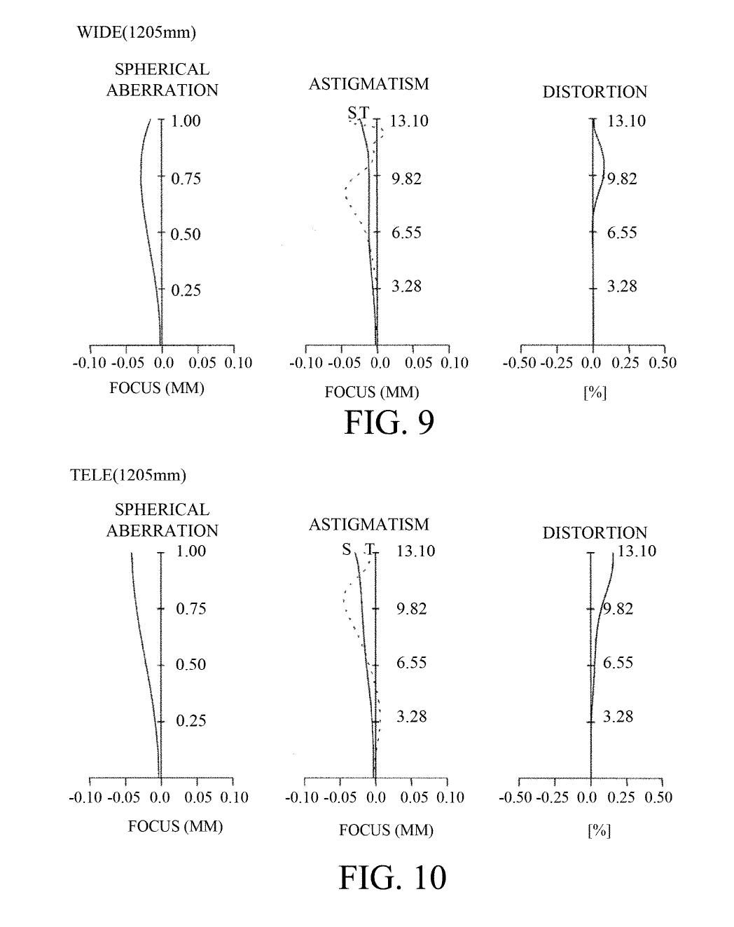

This embodiment is different from the first embodiment in that a ratio of the refractive power of the third lens to that of the second lens is larger, and the number of aspheric lenses in the first lens unit is reduced by one. FIG. 8 illustrates a simplified configuration of an image projection apparatus using the imaging optical system (with a projection distance 1205 mm) according to this embodiment as a projection lens. The image projection apparatus includes, in order from the enlargement conjugate side, an imaging optical system 21, a prism unit 22, and an image display element 23. FIG. 9 is a longitudinal aberration diagram of the imaging optical system 21 at a wide-angle end. FIG. 10 is a longitudinal aberration diagram of the imaging optical system 21 at a telephoto end.

The imaging optical system 21 includes, in order from the enlargement conjugate side, a front unit, a diaphragm ST2, and a rear unit. The front unit includes, in order from the enlargement conjugate side, a first lens unit B21 that is fixed in the magnification variation and has a negative refractive power, a second lens unit B22 that is movable in the magnification variation and has a positive refractive power, and a third lens unit B23 that is movable in the magnification variation and has a positive refractive power. The rear unit includes, in order from the enlargement conjugate side, a fourth lens unit B24 that is movable in the magnification variation and has a negative refractive power, and a fifth lens unit B25 that is fixed in the magnification variation and has a positive refractive power.

The first lens unit B21 includes, in order from the enlargement conjugate side, a lens L31 having a negative refractive power, a lens L32 having at least one aspherical surface and a meniscus shape with a negative refractive power, a lens L33 having a negative refractive power and an aspherical surface on the enlargement conjugation side, a lens L34 having a negative refractive power, a lens L35 having a negative refractive power, and a lens L36 having a positive refractive power. The second lens unit B22 includes a lens L37 having a positive refractive power. The third lens unit B23 includes a lens L38 having a positive refractive power. The fourth lens unit B24 includes, in order from the enlargement conjugate side, a lens L39 having a negative refractive power, a lens L40 having a positive refractive power, a lens L41 having a negative refractive power, a lens L42 having a positive refractive power, and a lens L43 having a positive refractive power. The fifth lens unit B25 includes a lens L44 having a positive refractive power.

The imaging optical system 21 according to this embodiment satisfies each conditional expression as illustrated in “(C) value of the conditional expression” of Numerical Example 2.

The above configuration can realize the retrofocus type imaging optical system 21 having a simple configuration and a good optical performance because the off-axis aberration is corrected. In this embodiment, since the number of aspheric lenses is reduced, the off-axis aberration is larger than that in the first embodiment. However, this embodiment can increase the design freedom such as improving the temperature characteristic.

### Third Embodiment

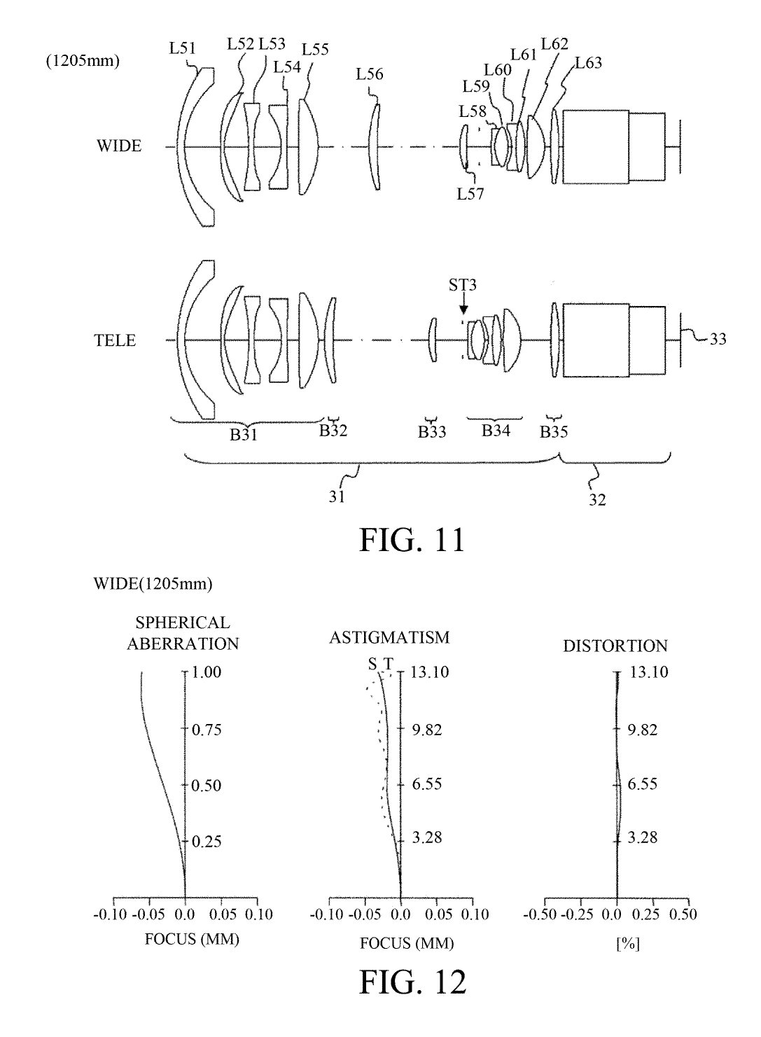

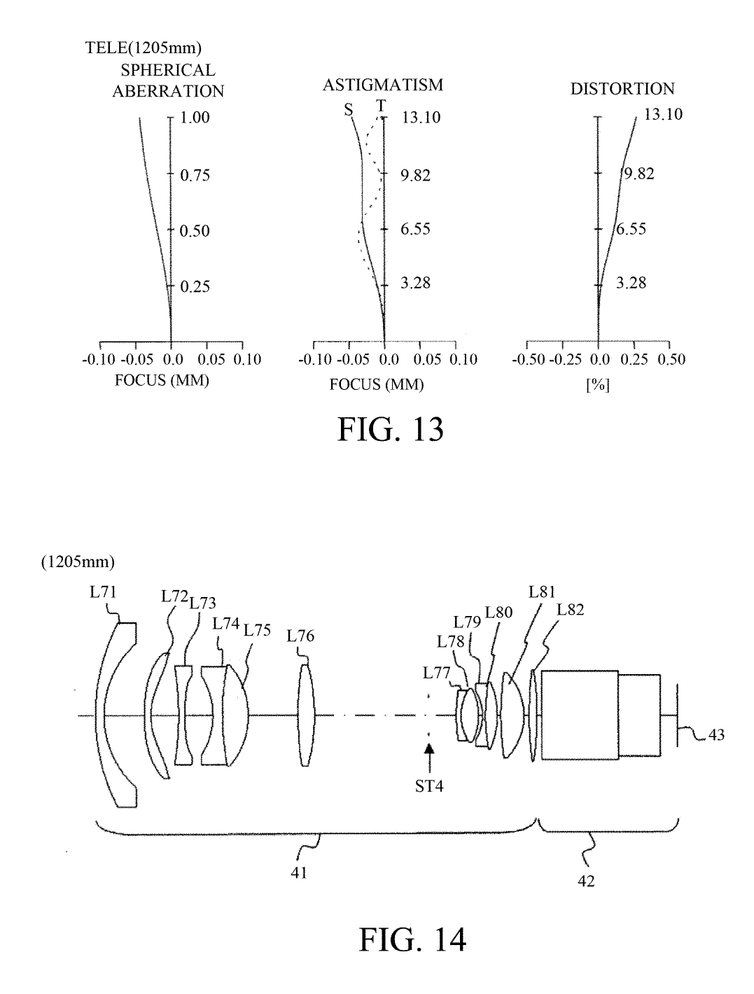

This embodiment changes a surface shape of the aspheric lens in the imaging optical system according to the first embodiment. FIG. 11 illustrates a simplified configuration of an image projection apparatus using the imaging optical system (with a projection distance 1205 mm) according to this example as a projection lens. The image projection apparatus includes, in order from the enlargement conjugate side, an imaging optical system 31, a prism unit 32, and an image display element 33. FIG. 12 is a longitudinal aberration diagram of the imaging optical system 31 at a wide-angle end. FIG. 13 is a longitudinal aberration diagram at a telephoto end of the imaging optical system 31.

The imaging optical system 31 includes, in order from the enlargement conjugate side, a front unit, a diaphragm ST3, and a rear unit. The front unit includes, in order from the enlargement conjugate side, a first lens unit B31 that is fixed in the magnification variation and has a negative refractive power, a second lens unit B32 that is movable in the magnification variation and has a positive refractive power, and a third lens unit B33 that is movable in the magnification variation and has a positive refractive power. The rear unit includes, in order from the enlargement conjugate side, a fourth lens unit B34 that is movable in the magnification variation and has a negative refractive power, and a fifth lens unit B35 that is fixed in the magnification variation and has a positive refractive power.

The first lens unit B31 includes, in order from the enlargement conjugate side, a lens L51 having a negative refractive power, a lens L52 having at least one aspherical surface and a meniscus shape with a negative refractive power, a lens L53 having a negative refractive power and an aspheric surface on the enlargement conjugate side, a lens L54 having a negative refractive power, and a lens L55 having a negative refractive power. The second lens unit B32 includes a lens L56 having a positive refractive power. The third lens unit B33 includes a lens L57 having a positive refractive power. The fourth lens unit B34 includes, in order from the enlargement conjugate side, a lens L58 having a negative refractive power, a lens L59 having a positive refractive power, a lens L60 having a negative refractive power, a lens L61 having a positive refractive power, and a lens L62 having a positive refractive power. The fifth lens unit B35 includes a lens L63 having a positive refractive power.

The imaging optical system 31 according to this embodiment satisfies the conditional expressions (1), (2), (2)′ as illustrated in the “(C) value expression value” in Numerical Example 3. However, the imaging optical system 31 according to this embodiment does not satisfy the conditional expression (1)′. Although the off-axis aberration becomes relatively large, the design freedom can be improved.

The above configuration can realize the retrofocus type imaging optical system 31 having a simple configuration and a good optical performance because the off-axis aberration is corrected.

### Fourth Embodiment

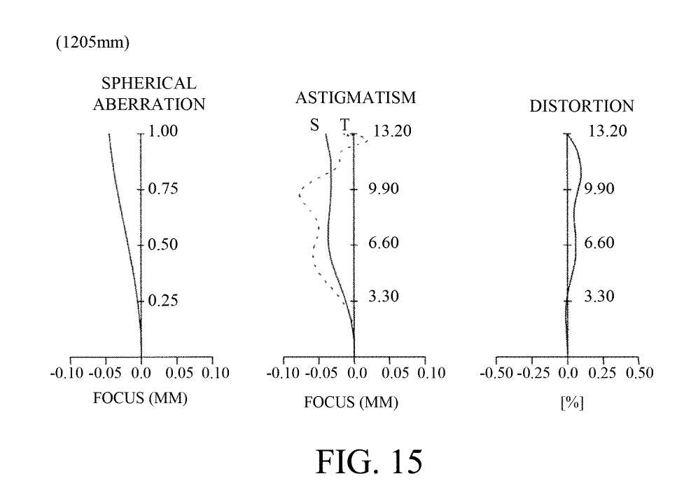

This embodiment removes the magnification varying function from the imaging optical system according to the first embodiment. FIG. 14 illustrates a simplified configuration of an image projection apparatus using the imaging optical system (with a projection distance 1205 mm) according to this embodiment as a projection lens. The image projection apparatus includes, in order from the magnification conjugation side, an imaging optical system 41, a prism unit 42, and an image display element 43. FIG. 15 is a longitudinal aberration diagram of the imaging optical system 41.

The imaging optical system 41 includes, in order from the enlargement conjugate side, a front unit, a diaphragm ST4, and a rear unit. The front unit includes, in order from the enlargement conjugate side, a lens L71 having a negative refractive power, a lens L72 having at least one aspherical surface and a meniscus shape with a negative refractive power, a lens L73 having a negative refractive power and an aspherical surface on the enlargement conjugate side, a lens L74 having a negative refractive power, a lens L75 having a positive refractive power, and a lens L76 having a positive refractive power. The rear unit includes, in order from the enlargement conjugate side, a lens L77 having a negative refractive power, a lens L78 having a positive refractive power, a lens L79 having a negative refractive power, a lens L80 having a positive refractive power, a lens L81 having a positive refractive power, and a lens L82 having a positive refractive power.

The imaging optical system 41 according to this embodiment satisfies each conditional expression as illustrated in “(C) value of the conditional expression” of the numerical example 4.

The above configuration can realize the retrofocus type imaging optical system 41 having a simple configuration and a good optical performance because the off-axis aberration is corrected.

### NUMERICAL EXAMPLE

Numerical Examples 1 to 4 corresponding to the first to fourth embodiments are shown below. In each numerical example “(A) lens configuration,” f is a focal length, F is a F-number, ri is a radius of curvature of an i-th surface from the object side, di is a distance between the i-th surface and an (i+1)-th surface, ni and vi are refractive index and the Abbe number of the material of an i-th optical element, and ST is a position of a diaphragm (stop aperture).

The left asterisked surface means an aspheric shape according to the following expression (3), and its coefficient is shown in “(B) aspherical coefficient.” In addition, y is a coordinate in a radial direction, z is a coordinate in a direction of the optical axis, k is a conical coefficient, and e-X is 10-X.

z(y)=(y²/ri)/[1+{1−(1+k)(y²/ri²)}^{1/2}]+Ay²+By³+Cy⁴+Dy⁵+Ey⁶+Fy⁷+Gy⁸+Hy⁹+Iy¹⁰+Jy¹¹+Ly¹²+My¹³+Ny¹⁴+Oy¹⁵+Py¹⁶ (3)

### Numerical Example 1

(A) Lens configuration

| | Wide-angle | Telephoto |
|---|---|---|
| f (focal length) | 12.66 | 15.83 |
| F-number | 2.80 | 2.88 |
| View angle | 46.1 | 39.7 |
| Lens overall length | 187.0 | |
| BF | 59.2 | |
| Zoom ratio | 1.25 | |

| | | | | |
|---|---|---|---|---|
| | r1 = 69.18 | d1 = 3.60 | n1 = 1.883 | ν1 = 40.8 |
| | r2 = 41.00 | d2 = 18.34 | | |
| * | r3 = 100.43 | d3 = 2.70 | n2 = 1.694 | ν2 = 53.2 |
| * | r4 = 27.18 | d4 = 12.20 | | |
| * | r5 = −101.97 | d5 = 2.70 | n3 = 1.854 | ν3 = 40.4 |
| * | r6 = 145.70 | d6 = 12.60 | | |
| | r7 = −27.78 | d7 = 2.90 | n4 = 1.497 | ν4 = 81.5 |
| | r8 = 151.70 | d8 = 4.96 | | |
| * | r9 = 230.76 | d10 = 9.89 | n5 = 1.731 | ν5 = 40.5 |
| * | r10 = −40.03 | d11 = variable | | |
| | r11 = 66.14 | d12 = 4.19 | n6 = 1.720 | ν6 = 34.7 |
| | r12 = 194.14 | d13 = variable | | |
| | r13 = 29.01 | d14 = 3.38 | n7 = 1.488 | ν7 = 70.2 |
| | r14 = 136.87 | d15 = variable | | |
| ST | r15 = ∞ | d16 = variable | | |
| | r16 = 113.3081838 | d17 = 1.75 | n8 = 1.883 | ν8 = 40.8 |
| | r17 = 15.99 | d18 = 6.42 | n9 = 1.516 | ν9 = 64.1 |
| | r18 = −22.03 | d19 = 1.81 | | |
| | r19 = −16.89 | d20 = 2.00 | n10 = 1.904 | ν10 = 31.3 |
| | r20 = 63.78 | d21 = 4.05 | n11 = 1.488 | ν11 = 70.2 |
| | r21 = −38.80 | d22 = 1.01 | | |
| | r22 = 149.57 | d23 = 8.35 | n12 = 1.439 | ν12 = 94.9 |
| | r23 = −20.54 | d24 = variable | | |
| | r24 = 179.89 | d25 = 3.92 | n13 = 1.893 | ν13 = 20.4 |
| | r25 = −91.04 | d26 = 2.00 | | |
| | r26 = ∞ | d27 = 32.32 | n14 = 1.516 | ν14 = 64.0 |
| | r27 = ∞ | d28 = 17.7 | n15 = 1.841 | ν15 = 25.0 |
| | r28 = ∞ | d29 = 7.22 | | |
| | r29 = ∞ | d30 = 0.00 | | |

In magnification variation (1205 mm)

| Distance between units | Wide-angle | Telephoto |
|---|---|---|
| d10 | 26.05 | 3.52 |
| d12 | 36.25 | 43.75 |
| d14 | 8.43 | 14.18 |
| d15 | 5.09 | 2.50 |
| d23 | 4.38 | 16.26 |

(B) Aspheric surface coefficient

| | K | A | B | C |
|---|---|---|---|---|
| r3 | 0 | 6.81E−06 | 7.02E−09 | −2.08E−11 |
| r4 | 0 | −2.04E−05 | 1.41E−08 | −1.96E−11 |
| r5 | 0 | −1.26E−05 | 1.25E−08 | 3.89E−11 |
| r6 | 0 | 1.40E−05 | 1.06E−08 | −3.64E−12 |
| r9 | 0 | 6.25E−06 | −7.94E−09 | −3.06E−12 |
| r10 | 0 | 2.83E−06 | 2.57E−09 | −5.80E−12 |
| | D | E | F | G |
| r3 | 2.54E−14 | −1.19E−18 | −3.03E−20 | 2.88E−23 |
| r4 | −1.73E−13 | 4.12E−16 | −2.50E−19 | −4.64E−23 |
| r5 | −8.19E−15 | −1.39E−16 | 1.15E−19 | 0.00E+00 |
| r6 | 8.72E−14 | −7.78E−17 | 1.30E−19 | 0.00E+00 |
| r9 | 3.36E−15 | 1.29E−17 | −7.36E−21 | 0.00E+00 |
| r10 | −3.96E−15 | 7.00E−18 | 6.11E−21 | 0.00E+00 |

(C) Value of conditional expression

| | |
|---|---|
| (1), (1)′ | 0.64r |
| (2), (2)′ | 1.28 |

Reference value

| | |
|---|---|
| r | 23.20 |
| Point of extreme value | 14.85 |
| Ratio b/a | 0.64 |

### Numerical Example 2

(A) Lens configuration

| | Wide-angle | Telephoto |
|---|---|---|
| f (focal length) | 12.66 | 15.84 |
| F-number | 2.80 | 2.88 |
| View angle | 45.8 | 39.5 |
| Lens overall length | 187.0 | |
| BF | 59.2 | |
| Zoom ratio | 1.25 | |

| | | | | |
|---|---|---|---|---|
| | r1 = 66.23 | d1 = 3.60 | n1 = 1.804 | ν1 = 46.6 |
| | r2 = 41.00 | d2 = 17.66 | | |
| * | r3 = 79.77 | d3 = 2.70 | n2 = 1.694 | ν2 = 53.2 |
| * | r4 = 26.67 | d4 = 12.02 | | |
| * | r5 = −102.11 | d5 = 2.70 | n3 = 1.854 | ν3 = 40.4 |
| * | r6 = 86.90 | d6 = 11.77 | | |
| | r7 = −35.82 | d7 = 3.00 | n4 = 1.497 | ν4 = 81.5 |
| | r8 = 82.92 | d8 = 6.28 | | |
| | r9 = 88.79 | d10 = 2.00 | n5 = 1.850 | ν5 = 32.3 |
| | r10 = 38.82 | d11 = 12 | n6 = 1.749 | ν6 = 35.3 |
| | r11 = −53.59 | d12 = variable | | |
| | r12 = 63.73 | d13 = 4.19 | n7 = 1.639 | ν7 = 44.9 |
| | r13 = 624.01 | d14 = variable | | |
| | r14 = 27.22 | d15 = 3.25 | n8 = 1.488 | ν8 = 70.2 |
| | r15 = 78.84 | d16 = variable | | |
| ST | r16 = ∞ | d17 = variable | | |
| | r17 = 143.49 | d18 = 1.75 | n9 = 1.883 | ν9 = 40.8 |
| | r18 = 15.88 | d19 = 6.52 | n10 = 1.516 | ν10 = 64.1 |
| | r19 = −21.91 | d20 = 1.78 | | |
| | r20 = −17.18 | d21 = 2.00 | n11 = 1.904 | ν11 = 31.3 |
| | r21 = 60.49 | d22 = 4.28 | n12 = 1.488 | ν12 = 70.2 |
| | r22 = −37.33 | d23 = 1.00 | | |
| | r23 = 129.97 | d24 = 8.69 | n13 = 1.439 | ν13 = 94.9 |
| | r24 = −21.11 | d25 = variable | | |
| | r25 = 155.86 | d26 = 3.93 | n14 = 1.893 | ν14 = 20.4 |
| | r26 = −102.03 | d27 = 2.00 | | |
| | r27 = ∞ | d28 = 32.32 | n15 = 1.516 | ν15 = 64.0 |
| | r28 = ∞ | d29 = 17.70 | n16 = 1.841 | ν16 = 25.0 |
| | r29 = ∞ | d30 = 7.22 | | |

In magnification variation (1205 mm)

| Distance between units | Wide-angle | Telephoto |
|---|---|---|
| d11 | 30.67 | 9.32 |
| d13 | 30.57 | 37.77 |
| d15 | 6.06 | 10.98 |
| d16 | 5.61 | 2.50 |
| d24 | 3.00 | 15.33 |

(B) Aspheric surface coefficient

| | K | A | B | C |
|---|---|---|---|---|
| r3 | 0 | 5.10E−06 | 5.46E−09 | −1.90E−11 |
| r4 | 0 | −1.69E−05 | 2.06E−09 | −2.15E−11 |
| r5 | 0 | −9.92E−06 | 1.96E−08 | 3.17E−11 |
| r6 | 0 | 8.68E−06 | 2.64E−08 | 5.12E−11 |
| | D | E | F | G |
| r3 | 3.16E−14 | −1.56E−17 | −4.50E−20 | 6.34E−23 |
| r4 | −1.58E−13 | 4.21E−16 | −2.34E−19 | −9.39E−23 |
| r5 | −6.33E−14 | −8.58E−17 | 1.48E−19 | 0.00E+00 |
| r6 | 1.25E−13 | −5.44E−16 | −1.28E−19 | 0.00E+00 |

(C) Value of conditional expression

| | |
|---|---|
| (1), (1)′ | 0.65r |
| (2), (2)′ | 0.92 |

Reference value

| | |
|---|---|
| r | 23.10 |
| Point of extreme value | 15.02 |
| Ratio b/a | 0.65 |

### Numerical Example 3

(A) Lens configuration

| | Wide-angle | Telephoto |
|---|---|---|
| f (focal length) | 12.66 | 15.83 |
| F-number | 2.80 | 2.88 |
| View angle | 46.1 | 39.7 |
| Lens overall length | 187.0 | |
| BF | 59.2 | |
| Zoom ratio | 1.25 | |

| | | | | |
|---|---|---|---|---|
| | r1 = 67.52 | d1 = 3.60 | n1 = 1.883 | ν1 = 40.8 |
| | r2 = 41.00 | d2 = 17.52 | | |
| * | r3 = 102.75 | d3 = 2.00 | n2 = 1.694 | ν2 = 53.2 |
| * | r4 = 26.69 | d4 = 11.80 | | |
| * | r5 = −151.84 | d5 = 2.70 | n3 = 1.854 | ν3 = 40.4 |
| * | r6 = 132.69 | d6 = 13.39 | | |
| | r7 = −27.19 | d7 = 2.90 | n4 = 1.497 | ν4 = 81.5 |
| | r8 = 630.60 | d8 = 5.57 | | |
| * | r9 = −1123.14 | d10 = 9.68 | n5 = 1.731 | ν5 = 40.5 |
| * | r10 = −38.68 | d11 = variable | | |
| | r11 = 59.16 | d12 = 4.29 | n6 = 1.720 | ν6 = 34.7 |
| | r12 = 159.62 | d13 = variable | | |
| | r13 = 29.12 | d14 = 3.30 | n7 = 1.488 | ν7 = 70.2 |
| | r14 = 112.21 | d15 = variable | | |
| ST | r15 = ∞ | d16 = variable | | |
| | r16 = 115.76 | d17 = 1.75 | n8 = 1.883 | ν8 = 40.8 |
| | r17 = 17.22 | d18 = 6.48 | n9 = 1.516 | ν9 = 64.1 |
| | r18 = −23.75 | d19 = 1.91 | | |
| | r19 = −17.59 | d20 = 2.00 | n10 = 1.904 | ν10 = 31.3 |
| | r20 = 62.52 | d21 = 4.41 | n11 = 1.488 | ν11 = 70.2 |
| | r21 = −36.69 | d22 = 1.00 | | |
| | r22 = 169.87 | d23 = 8.60 | n12 = 1.439 | ν12 = 94.9 |
| | r23 = −21.45 | d24 = variable | | |
| | r24 = 173.18 | d25 = 4.01 | n13 = 1.893 | ν13 = 20.4 |
| | r25 = −93.85 | d26 = 2.00 | | |
| | r26 = ∞ | d27 = 32.32 | n14 = 1.516 | ν14 = 64.0 |
| | r27 = ∞ | d28 = 17.7 | n15 = 1.841 | ν15 = 25.0 |
| | r28 = ∞ | d29 = 7.65 | | |

In magnification variation (1205 mm)

| Distance between units | Wide-angle | Telephoto |
|---|---|---|
| d10 | 25.10 | 3.00 |
| d12 | 40.83 | 47.42 |
| d14 | 6.13 | 13.31 |
| d15 | 5.98 | 2.50 |
| d23 | 3.00 | 14.80 |

(B) Aspheric surface coefficient

| | K | A | B | C |
|---|---|---|---|---|
| r3 | 0 | 6.98E−06 | 8.13E−09 | −2.04E−11 |
| r4 | 0 | −2.13E−05 | 1.72E−08 | −1.49E−11 |
| r5 | 0 | −1.23E−05 | 1.31E−08 | 3.71E−11 |
| r6 | 0 | 1.45E−05 | 1.16E−08 | 7.78E−12 |
| r9 | 0 | 6.95E−06 | −8.32E−09 | −3.03E−12 |
| r10 | 0 | 2.94E−06 | 1.70E−09 | −5.15E−12 |
| | D | E | F | G |
| r3 | 2.75E−14 | −2.58E−19 | −3.04E−20 | 3.91E−23 |
| r4 | −1.71E−13 | 4.09E−16 | −2.62E−19 | −6.50E−23 |
| r5 | −1.73E−14 | −1.54E−16 | 1.67E−19 | 0.00E+00 |
| r6 | 5.28E−14 | −2.00E−16 | 5.84E−19 | 0.00E+00 |
| r9 | 5.22E−15 | 1.58E−17 | −1.38E−20 | 0.00E+00 |
| r10 | −2.17E−15 | 8.26E−18 | 2.70E−21 | 0.00E+00 |

(C) Value of conditional expression

| | |
|---|---|
| (1), (1)′ | 0.77r |
| (2), (2)′ | 1.57 |

Reference value

| | |
|---|---|
| r | 23.10 |
| Point of extreme value | 17.79 |
| Ratio b/a | 0.77 |

### Numerical Example 4

(A) Lens configuration

| | |
|---|---|
| f (focal length) | 12.64 |
| F-number | 2.80 |
| View angle | 46.1 |
| Lens overall length | 187.0 |
| BF | 59.2 |

| | | | | |
|---|---|---|---|---|
| | r1 = 84.94 | d1 = 3.60 | n1 = 1.777 | ν1 = 48.4 |
| | r2 = 41.00 | d2 = 17.05 | | |
| * | r3 = 91.45 | d3 = 2.70 | n2 = 1.744 | ν2 = 51.6 |
| * | r4 = 27.01 | d4 = 11.75 | | |
| * | r5 = −199.23 | d5 = 2.70 | n3 = 1.834 | ν3 = 37.2 |
| * | r6 = 154.05 | d6 = 11.74 | | |
| | r7 = −31.14 | d7 = 4.00 | n4 = 1.773 | ν4 = 49.6 |
| | r8 = 111.84 | d8 = 11.00 | n5 = 1.610 | ν5 = 36.9 |
| * | r9 = −32.61 | d10 = 20.98 | | |
| | r10 = 131.29 | d11 = 7.13 | n6 = 1.761 | ν6 = 45.7 |
| | r11 = −78.64 | d12 = 48.68 | | |
| ST | r12 = ∞ | d13 = 11.58 | | |
| | r13 = 73.45 | d14 = 2.00 | n7 = 1.834 | ν7 = 37.2 |
| | r14 = 20.39 | d15 = 7.44 | n8 = 1.487 | ν8 = 70.2 |
| | r15 = −24.49 | d16 = 1.61 | | |
| | r16 = −20.43 | d17 = 1.30 | n9 = 1.850 | ν9 = 32.3 |
| | r17 = 83.26 | d18 = 5.01 | n10 = 1.487 | ν10 = 70.2 |
| | r18 = −35.13 | d19 = 1.50 | | |
| | r19 = 132.36 | d20 = 9.70 | n11 = 1.439 | ν11 = 94.9 |
| | r20 = −25.86 | d21 = 2.17 | | |
| | r21 = 157.95 | d22 = 3.35 | n12 = 1.893 | ν12 = 20.4 |
| | r22 = −128.89 | d23 = 2.00 | | |
| | r23 = ∞ | d24 = 32.32 | n13 = 1.516 | ν13 = 64.0 |
| | r24 = ∞ | d25 = 17.70 | n14 = 1.841 | ν14 = 25.0 |
| | r25 = ∞ | d26 = 7.26 | | |

(B) Aspheric surface coefficient

| | K | A | B | C |
|---|---|---|---|---|
| r3 | 0 | 9.35E−06 | −1.06E−09 | −9.71E−12 |
| r4 | 0 | −1.64E−05 | 8.48E−09 | −2.47E−11 |
| r5 | 0 | −1.30E−05 | 1.59E−08 | 3.93E−11 |
| r6 | 0 | 1.08E−05 | 1.44E−08 | 8.34E−11 |
| r9 | 0 | −4.58E−07 | 2.83E−09 | −5.90E−12 |
| | D | E | F | G |
| r3 | 2.65E−14 | −1.33E−17 | −4.24E−20 | 4.88E−23 |
| r4 | −1.70E−13 | 4.24E−16 | −2.39E−19 | −7.24E−23 |
| r5 | −1.24E−14 | −1.65E−16 | 1.52E−19 | 0.00E+00 |
| r6 | 1.06E−13 | −1.83E−16 | −2.01E−19 | 0.00E+00 |
| r9 | −2.79E−15 | 2.17E−17 | −3.33E−21 | −4.63E−23 |

(C) Value of conditional expression

| | |
|---|---|
| (1), (1)′ | 0.64r |
| (2), (2)′ | 1.98 |

Reference value

| | |
|---|---|
| r | 23.30 |
| point of extreme value | 14.91 |
| Ratio b/a | 0.64 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-209690, filed on Oct. 30, 2017, which is hereby incorporated by reference herein in its entirety.

What is claimed is:

1. An imaging optical system comprising;
in order from an enlargement conjugate side,
a front unit;
a diaphragm; and
a rear unit,
wherein the front unit includes, in order from the enlargement conjugate side, a first lens having a negative refracting power, a second lens having at least one aspherical surface and a meniscus shape with a negative refracting power, and a third lens having an aspherical concave surface on the enlargement conjugate side and a negative refractive power,
wherein the second lens has a positive refractive power at a periphery, and a surface in which the periphery and a center have curvatures with different signs each other, and
wherein the following conditional expression is satisfied:
0.5r≤rk≤0.75r
where rk is a distance from an optical axis to a position corresponding to an arbitrary extreme value on the surface of the second lens in which the periphery and a center have curvatures with different signs each other, in a direction orthogonal to the optical axis, and r is a lens radius.

2. The imaging optical system according to claim 1, wherein the surface of the second lens in which the periphery and a center have curvatures with different signs is located on a reduction conjugate side of the second lens.

3. The imaging optical system according to claim 1, wherein the following conditional expression is satisfied:
0.5≤φ2/φ3≤4.0
where φ2 is a refractive power of the second lens and φ3 is a refractive power of the third lens.

4. The imaging optical system according to claim 1, wherein the following conditional expression is satisfied:
0.8≤φ2/φ3≤2.5
where φ2 is a refractive power of the second lens and φ3 is a refractive power of the third lens.

5. The imaging optical system according to claim 1, wherein the first lens is a spherical lens.

6. The imaging optical system according to claim 1, wherein the front unit includes, in order from the enlargement conjugate side, a first lens unit that is fixed in a magnification variation and has a negative refractive power, a second lens unit that is movable in the magnification variation and has a positive refractive power, and a third lens unit that is movable in the magnification variation and has a positive refractive power, and
wherein the rear unit includes, in order from the enlargement conjugate side, a fourth lens unit that is movable in the magnification variation and has a negative refractive power, and a fifth lens unit that is fixed in the magnification variation and has a positive refractive power.

7. An image projection apparatus comprising an imaging optical system, an image display element, and a light guiding optical system for guiding light from the image display element to the imaging optical system,
wherein the imaging optical system includes, in order from an enlargement conjugate side, a front unit, a diaphragm, and a rear unit,
wherein the front unit includes, in order from the enlargement conjugate side, a first lens having a negative refracting power, a second lens having at least one aspherical surface and a meniscus shape with a negative refracting power, and a third lens having an aspherical concave surface on the enlargement conjugate side and a negative refractive power,
wherein the second lens has a positive refractive power at a periphery, and a surface in which the periphery and a center have curvatures with different signs each other, and
wherein the following conditional expression is satisfied:
0.5r≤rk≤0.75r
where rk is a distance from an optical axis to a position corresponding to an arbitrary extreme value on the surface of the second lens in which the periphery and a center have curvatures with different signs each other, in a direction orthogonal to the optical axis, and r is a lens radius.

8. An imaging apparatus comprising:
an imaging optical system; and
an image sensor configured to receive light formed by the imaging optical system,
wherein the imaging optical system includes, in order from an enlargement conjugate side, a front unit, a diaphragm, and a rear unit,
wherein the front unit includes, in order from the enlargement conjugate side, a first lens having a negative refracting power, a second lens having at least one aspherical surface and a meniscus shape with a negative refracting power, and a third lens having an aspherical concave surface on the enlargement conjugate side and a negative refractive power,
wherein the second lens has a positive refractive power at a periphery, and a surface in which the periphery and a center have curvatures with different signs each other, and
wherein the following conditional expression is satisfied:
0.5r≤rk≤0.75r
where rk is a distance from an optical axis to a position corresponding to an arbitrary extreme value on the surface of the second lens in which the periphery and a center have curvatures with different signs each other, in a direction orthogonal to the optical axis, and r is a lens radius.
